(19) United States
(12) Patent Application Publication
(10) Pub. No.: US 2026/0181326 A1
(43) Pub. Date: Jun. 25, 2026

(54) PROJECTION DEVICE, PROJECTION SYSTEM, AND NON-TRANSITORY COMPUTER-READABLE STORAGE MEDIUM STORING PROGRAM

(71) Applicant: SEIKO EPSON CORPORATION, Tokyo (JP)

(72) Inventor: Yoshihiro JINBO, OITA-SHI (JP)

(21) Appl. No.: 19/429,475

(22) Filed: Dec. 22, 2025

(30) Foreign Application Priority Data
Dec. 24, 2024 (JP) 2024-227104

(51) Int. Cl. H04R 3/12; H04N 9/31; H04R 1/02; H04R 1/40

(52) U.S. Cl. CPC H04R 3/12; H04N 9/3141; H04R 1/028; H04R 1/403; H04R 2499/15

(57) ABSTRACT

According to an aspect of the present disclosure, there is provided a projection device including a distance sensor configured to measure distances to a plurality of positions on a screen and output measurement values indicating the measured distances to the plurality of positions, a plurality of speakers, a processor, and a projector configured to project an image onto the screen. The processor executes calculating a tilt of the projector with respect to the screen based on the measurement values output by the distance sensor and controlling outputs of the plurality of speakers based on the tilt.

The present application is based on, and claims priority from JP Application Serial Number 2024-227104, filed Dec. 24, 2024, the disclosure of which is hereby incorporated by reference herein in its entirety.

### BACKGROUND

### 1. Technical Field

The present disclosure relates to a projection device, a projection system, and a non-transitory computer-readable storage medium storing a program.

### 2. Related Art

In the related art, there is known a technique of changing, based on a positional relationship between a projection surface and a projection device, a left-right balance of speakers provided in a projector.

For example, a projector disclosed in JP-A-2009-229939 includes a lens parameter acquisition unit that acquires positional relationship parameters relating to a positional relationship between an installation position of the projector and a formation position of a projection image on a projection surface. The lens parameter acquisition unit acquires a movement amount of the zoom lens, a movement amount of a focus lens, and a lens shift amount as positional relationship parameters based on manual operation performed by a user. The projector corrects an audio signal based on the acquired positional relationship parameters and outputs the corrected audio signal to a plurality of speakers.

JP-A-2009-229939 is an example of the related art.

However, in the projector disclosed in JP-A-2009-229939, the user needs to move the zoom lens and the focus lens with the manual operation and determine parameters for geometric correction, lens shift, and focus correction. For this reason, there is a problem in that, when the user has not successfully input accurate parameters with the manual operation, the user feels a volume balance of left and right speakers bad.

### SUMMARY

According to an aspect of the present disclosure, there is provided a projection device including: a distance sensor configured to measure distances to a plurality of positions on a projection surface and output measurement values indicating the measured distances to the plurality of positions; a plurality of speakers; one or a plurality of processors; and a projector configured to project an image onto the projection surface, wherein the one or the plurality of processors execute: calculating a tilt of the projector with respect to the projection surface based on the measurement values output by the distance sensor; and controlling outputs of the plurality of speakers based on the tilt.

According to an aspect of the present disclosure, there is provided a projection system including: a plurality of speakers; and a projection device, the projection device including: a distance sensor configured to measure distances to a plurality of positions on a projection surface and output measurement values indicating the measured distances to the plurality of positions; one or a plurality of processors; and a projector configured to project an image onto the projection surface, wherein the one or the plurality of processors execute: calculating a tilt of the projector with respect to the projection surface based on the measurement values output by the distance sensor; and controlling outputs of the plurality of speakers based on the tilt.

According to an aspect of the present disclosure, there is provided a non-transitory computer-readable storage medium storing a program to be executed by a processor mounted on an information processing device, the program causing the processor to execute: calculating a tilt of a projection device, which projects an image onto a projection surface, with respect to the projection surface based on distances to a plurality of positions on the projection surface measured by a distance sensor; and controlling outputs of a plurality of speakers based on the calculated tilt.

### BRIEF DESCRIPTION OF THE DRAWINGS

FIG. 1 is a block diagram illustrating a configuration of a projection device.

FIG. 2 is a perspective view illustrating the exterior of a projection device.

FIG. 3 is a diagram illustrating a configuration of a projector.

FIG. 4 is a diagram illustrating an angle formed by a screen and the projection device.

FIG. 5 is a diagram illustrating a disposition example of the projection device with respect to the screen.

FIG. 6 is a diagram illustrating an example in which the projection device is disposed near a wall in a room.

FIG. 7 is a flowchart illustrating an operation of the projection device.

### DESCRIPTION OF EMBODIMENTS

### 1. Configuration of a Projection Device

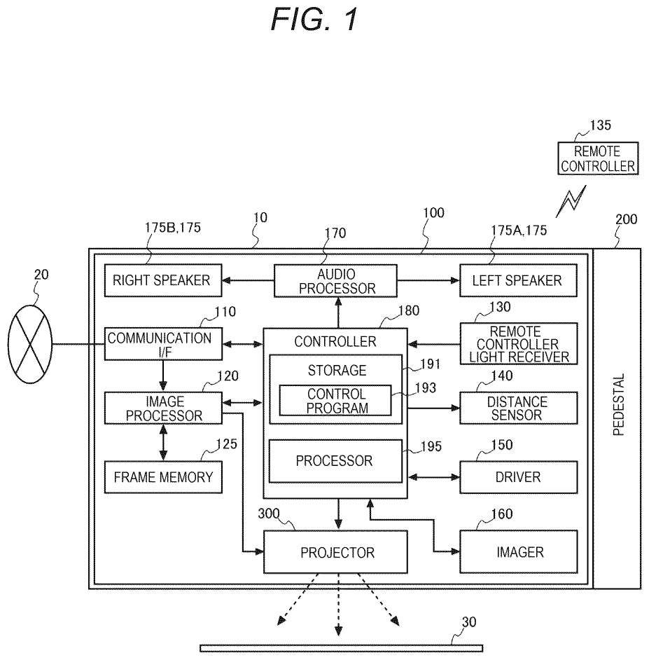

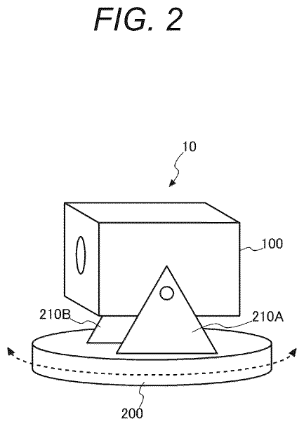

FIG. 1 is a block diagram illustrating a configuration of a projection device 10 and FIG. 2 is a perspective view illustrating the exterior of the projection device 10.

The configuration of the projection device 10 is explained with reference to FIGS. 1 and 2.

The projection device 10 includes a main body 100 and a pedestal 200.

In the main body 100, functional units that implement functions of the projection device 10 are provided. The functional units include a communication interface 110, an image processor 120, a frame memory 125, a remote controller light receiver 130, a distance sensor 140, a driver 150, an imager 160, a projector 300, an audio processor 170, speakers 175, and a controller 180 illustrated in FIG. 1. Hereinafter, interface is abbreviated as I/F.

The main body 100 is supported on the pedestal 200 by support members 210A and 210B illustrated in FIG. 2. The pedestal 200 is driven by a driver 150 provided in the main body 100 and is configured to be rotatable by 360 degrees in left rotation or right rotation in a direction horizontal to an installation surface on which the projection device 10 is installed. The left rotation or the right rotation in the horizontal direction is equivalent to rotation in a predetermined direction.

Next, the functional units provided in the main body 100 of the projection device 10 are explained.

The projection device 10 is a device that generates image light based on image data and projects the generated image light onto a screen 30, which is a projection surface. The image data may be, for example, data transmitted from an information processing device such as a personal computer connected via the network 20 or may be data stored in advance in a storage 191 of the projection device 10. In the present embodiment, a case in which the projection surface is the screen 30 is explained. However, the projection surface may be a wall surface of a room.

The communication I/F 110 includes a communication card such as a network interface card (NIC) and performs data communication with not-illustrated information processing device via the network 20. In FIG. 1, an example in which the communication I/F 110 is connected to the network 20 by wire is illustrated. However, the connection between the projection device 10 and the network 20 may be, for example, wireless connection by Wi-Fi. Wi-Fi is a registered trademark.

Image data received by the communication I/F 110 from the information processing device is input to the image processor 120. The frame memory 125 is coupled to the image processor 120. The frame memory 125 includes a plurality of banks. The banks have a storage capacity for enabling image data for one frame to be written. The frame memory 125 is, for example, a synchronous dynamic random access memory (SDRAM). The image processor 120 loads image data input from the communication I/F 110 in the frame memory 125.

The image processor 120 performs image processing on the image data loaded in the frame memory 125. Examples of the image processing performed by the image processor 120 include resolution conversion processing, resizing processing, distortion aberration correction, shape correction processing, digital zoom processing, and adjustment of a tint and luminance of an image. The image processor 120 executes processing designated by the controller 180 and, according to necessity, performs processing using parameters input from the controller 180. The image processor 120 is naturally capable of also executing, in combination, a plurality of kinds of image processing among the kinds of image processing described above. The image processor 120 reads, from the frame memory 125, image data loaded in a bank selected by the controller 180 and outputs the read image data to the projector 300.

The image processor 120 and the frame memory 125 include, for example, an integrated circuit. Examples of the integrated circuit include a large scale integration (LSI), an application specific integrated circuit (ASIC), a programmable logic device (PLD), a field-programmable gate array (FPGA), and a system-on-a-chip (SoC). An analog circuit may be provided in a part of a configuration of the integrated circuit. The controller 180 and the integrated circuit may be combined.

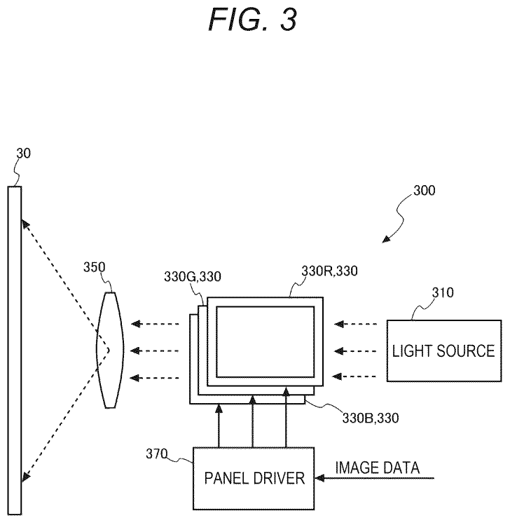

FIG. 3 is a diagram illustrating an example of a configuration of the projector 300.

Here, the configuration of the projector 300 is explained with reference to FIG. 3.

The projector 300 modulates light emitted from a light source 310 to generate image light and enlarges and projects the generated image light with an optical unit 350. The projector 300 includes the light source 310, three liquid crystal panels 330R, 330G, and 330B serving as light modulation devices, the optical unit 350, and a panel driver 370. Hereinafter, the liquid crystal panels 330R, 330G, and 330B provided in the projector 300 are collectively referred to as liquid crystal panels 330.

The light source 310 includes a discharge type light source lamp such as an ultra-high pressure mercury lamp or a metal halide lamp or a solid-state light source such as a light emitting diode or a semiconductor laser. The light emitted from the light source 310 is made incident on the liquid crystal panel 330. Each of the liquid crystal panels 330R, 330G, and 330B is implemented by a transmissive liquid crystal panel in which liquid crystal is encapsulated between a pair of transparent substrates. The liquid crystal panel 330R modulates red light, the liquid crystal panel 330G modulates green light, and the liquid crystal panel 330B modulates blue light. In the liquid crystal panel, a pixel region including a plurality of pixels arrayed in a matrix is formed. A drive voltage can be applied to the liquid crystal for each of the pixels.

Image data output by the image processor 120 is input to the panel driver 370. The panel driver 370 applies a drive voltage corresponding to the input image data to the pixels in the pixel region and sets the pixels to a light transmittance corresponding to the image data. The light emitted from the light source 310 is modulated for each of the pixels by being transmitted through pixel regions of the liquid crystal panels 330R, 330G, and 330B. Image light corresponding to the image data is formed for each color light. Formed image lights of the colors are combined for each of the pixels by a not-illustrated color combination optical system to be image light representing a color image. The optical unit 350 includes a projection lens and enlarges and projects the image lights modulated by the liquid crystal panels 330R, 330G, and 330B onto the screen 30.

Referring back to FIG. 1, the configuration of the projection device 10 is continuously explained.

The remote controller light receiver 130 receives an infrared signal transmitted from a remote controller 135. The remote controller 135 includes a plurality of buttons such as a power button, a source switching button, a volume button, and an image projection end button and transmits an infrared signal corresponding to a button operated by a user to the projection device 10. The remote controller light receiver 130 outputs an operation signal corresponding to the received infrared signal to the controller 180. The operation signal is a signal corresponding to the button of the remote controller 135 operated by the user.

The distance sensor 140 is a sensor that measures the distance to a target object. Examples of the target object include the screen 30, which is the projection surface, and an object such as a wall or a thing placed around the screen 30. In the present embodiment, a case in which the distance sensor 140 is a ToF (time of flight) sensor is explained. However, the distance sensor 140 is not limited to the ToF sensor. For example, the distance sensor 140 may be a LiDAR (light detection and ranging) sensor, may be an ultrasonic sensor, or may be a sensor that measures a distance using a stereo camera. The distance sensor 140 is preferably disposed at a position near the projection lens but is not particularly limited.

The driver 150 includes a drive device such as a motor and is coupled to a driving force propagation member such as a gear provided in the pedestal 200. When the motor of the driver 150 is rotated by the control of the controller 180, the pedestal 200 rotates in the horizontal left direction or the horizontal right direction.

The imager 160 is equivalent to a detection sensor. The imager 160 includes a lens and an imaging element. The lens and the imaging element are not illustrated in the figures. The lens causes the imaging element to form an image of incident light from an imaging range. The imaging element includes a charge coupled device (CCD) or a complementary metal oxide semiconductor (CMOS) and generates a captured image. The imager 160 outputs the generated captured image to the controller 180.

The audio processor 170 is, for example, a processor for audio processing. A left speaker 175A and a right speaker 175B are coupled to the audio processor 170. The left speaker 175A and the right speaker 175B are respectively disposed at both end portions in the width direction of the main body 100. The left speaker 175A is disposed on the left side of the projection device 10 when the projection device 10 is viewed from the back side. The right speaker 175B is disposed on the right side of the projection device 10 when the projection device 10 is viewed from the back side. Hereinafter, the left speaker 175A and the right speaker 175B are collectively referred to as speakers 175.

The audio processor 170 D/A-converts audio data input from the controller 180 into an analog audio signal. The audio processor 170 amplifies the converted audio signal and outputs the amplified audio signal from the speakers 175 as sound.

The controller 180 is a computer device including a storage 191 and a processor 195. In the present embodiment, the projection device 10 is equivalent to an information processing device. For this reason, the processor 195 is equivalent to a processor mounted on the information processing device.

The storage 191 includes a random access memory (RAM) and a read only memory (ROM). The RAM is used to temporarily store various data. The RAM stores, for example, a measurement value of a distance measured by the distance sensor 140. The ROM stores a control program 193 for controlling an operation of the processor 195 and various setting data. As explained below, the various setting data include a data set measured in advance in a state in which the projection device 10 is installed in parallel to the screen 30.

The processor 195 is an arithmetic processing device including a central processing unit (CPU) or a micro-processing unit (MPU). The processor 195 may be configured by a single processor or may be configured by a plurality of processors. The processor 195 may be configured by a SoC integrated with a part or the entire storage 191 or other circuits. The processor 195 may be configured by a combination of a CPU that executes a program and a digital signal processor (DSP) that executes predetermined arithmetic processing. Further, all functions of the processor 195 may be implemented in hardware or may be configured using a programmable device. Various control functions implemented by the processor 195 executing the control program 193 stored in the storage 191 are sometimes be simply explained as operations of the controller 180 or operations of the processor 195.

The controller 180 acquires, from the storage 191, a measurement value measured by the distance sensor 140 and calculates a tilt of the projection device 10 with respect to the screen 30 based on the acquired measurement value.

The tilt of the projection device 10 with respect to the screen 30 is a tilt of a housing configuring the main body 100 of the projection device 10 with respect to the screen 30.

The tilt of the projection device 10 with respect to the screen 30 can also be expressed as a tilt of the projector 300 with respect to the screen 30. Specifically, the tilt of the projector 300 with respect to the screen 30 is a tilt with respect to the screen 30 in a horizontal plane orthogonal to an optical axis of the projection lens provided in the projector 300 when the projector 300 is fixed to the projection device 10.

The distance sensor 140 measures distances at a plurality of points on the screen 30 and outputs measurement values to the controller 180.

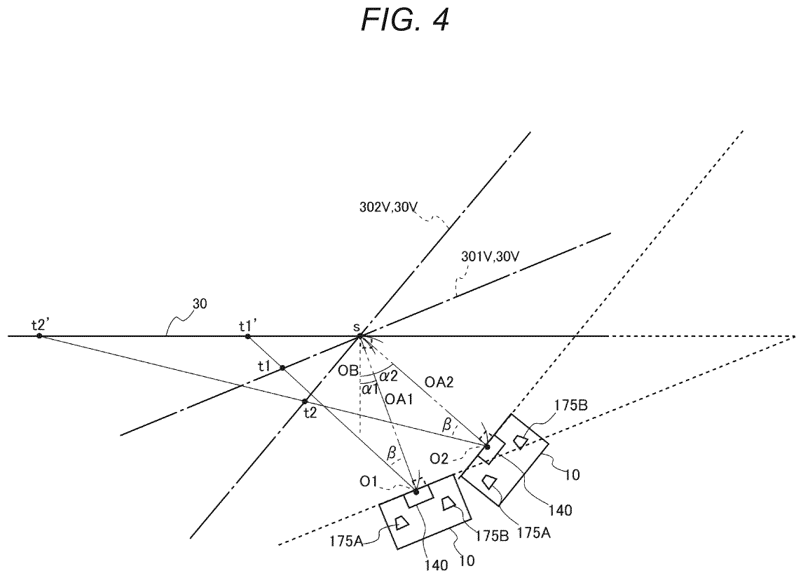

FIG. 4 is a diagram illustrating an angle α formed by the screen 30 and the projection device 10. FIG. 4 is a diagram illustrating a case in which the angle α formed by the projection device 10 and the screen 30 is an angle α1 and a case in which the angle α is an angle α2. Here, the angle α is an inclination angle of the optical axis of the projection lens with respect to the normal line of the screen 30.

In FIG. 4, a temporary screen 30V is indicated by an alternate long and short dash line. The temporary screen 30V indicates the screen 30 installed in parallel to the projection device 10. The temporary screen 30V includes a temporary screen 301V corresponding to the angle α1 and a temporary screen 302V corresponding to the angle α2.

Further, in FIG. 4, an optical axis direction OA of the projection lens is indicated by an alternate long and two short dashes line. The optical axis direction OA of the projection lens includes an optical axis direction OA1 of the projection lens corresponding to the angle α1 and an optical axis direction OA2 of the projection lens corresponding to the angle α2.

The controller 180 calculates the angle α formed by the screen 30 and the projection device 10. The angle α1 coincides with an angle formed by a normal line OB of the screen 30 and an optical axis direction OA1 of the projection lens of the projection device 10, the angle α of which formed with the screen 30 is the angle α1. The normal line OB of the screen 30 is indicated by a broken line. The angle α2 coincides with an angle formed by the normal line OB of the screen 30 and an optical axis direction OA2 of the projection lens of the projection device 10, the angle α of which formed with the screen 30 is the angle α2.

A point s illustrated in FIG. 4 indicates a point where the optical axis of the projection lens of the projection device 10 intersects the screen 30. A point t1′ illustrated in FIG. 4 indicates a point where a line segment, an angle of which formed with the optical axis of the projection lens of the projection device 10, the angle α of which formed with the screen 30 is the angle α1, is β intersects the screen 30 in the horizontal direction. A point t1 illustrated in FIG. 4 indicates a point where the line segment intersects the temporary screen 301V. A point t2′ illustrated in FIG. 4 indicates a point where a line segment, an angle of which formed with the optical axis of the projection lens of the projection device 10, the angle α of which formed with the screen 30 is the angle α2, is β intersects the screen 30 in the horizontal direction. A point t2 illustrated in FIG. 4 indicates a point where the line segment intersects the temporary screen 302V.

The setting data includes a set of data sets measured in advance in a state in which the projection device 10 is installed such that the projection device 10 is parallel to the screen 30 and a conversion table in which angles associated with ratios explained below are registered.

The first data of the data set is data indicating the distance between the projection device 10 and the screen 30 in the optical axis direction. That is, the first data is data indicating the distance between the projection device 10 and the screen 30 in an OA1 direction illustrated in FIG. 4. The first data is data measured by changing the distance between the projection device 10 and the screen 30 while the projection device 10 is kept parallel to the screen 30. This data is referred to as first data.

The second data of the data set is data indicating the distance between the projection device 10 and the screen 30 in a direction in which an angle formed with the optical axis is the angle β set in advance. That is, the second data is data obtained by measuring the distance from the projection device 10 to the point t1 illustrated in FIG. 4 while changing the distance between the projection device 10 and the screen 30. This data is referred to as second data.

The conversion table is a conversion table in which a ratio between the second data and measurement data in the direction in which the angle formed with the optical axis is the angle β set in advance is associated with the angle α formed by the screen 30 and the projection device 10.

An example of a method of creating the conversion table is explained.

First, a relationship between the angle α formed by the screen 30 and the projection device 10 and a value obtained by dividing the distance from the projection device 10 to the screen 30 in the direction in which the angle formed with the optical axis is the angle β set in advance by the distance from the projection device 10 to the temporary screen 30V is explained.

In FIG. 4, a position where the distance sensor 140 of the projection device 10 in which the angle α formed with the screen 30 is the angle α1 is represented as O1 and a position where the distance sensor 140 of the projection device 10 in which the angle α formed with the screen 30 is the angle α2 is represented as O2.

In FIG. 4, it is assumed that the angle α1 is smaller than the angle α2.

At this time, in the direction in which the angle formed with the optical axis is the angle β set in advance, a value obtained by dividing a distance O1t1′ from the projection device 10 in which the angle α formed with the screen 30 is the angle α1 to the screen 30 by a distance O1t1 from the projection device 10 in which the angle α formed with the screen 30 is the angle α1 to the temporary screen 301V, that is, a value indicating a ratio O1t1′/O1t1 of the two distances is calculated. From FIG. 4, the value indicating the ratio O1t1′/O1t1 of the distances calculated from the projection device 10 in which the angle α formed with the screen 30 is the angle α1 is smaller than a value indicating a ratio O2t2′/O2t2 of the distances calculated from the projection device 10 in which the angle α formed with the screen 30 is the angle α2. In other words, it is seen that, as the angle formed by the screen 30 and the projection device 10 increases, the value indicating the ratio of the distances increases.

By calculating the value indicating the ratio of the distances while changing the angle formed by the screen 30 and the projection device 10 in advance using the characteristics explained above, it is possible to create a conversion table in which the value indicating the ratio of the distances is associated with the angle. At the time of creating the conversion table, not only the value indicating the ratio of the distances and the angle are stored in association with each other but also non-linear interpolation may be performed in order to calculate a value indicating a ratio of distances corresponding to an angle that is not measured.

The controller 180 acquires measurement data in the optical axis direction of the projection lens of the projection device 10 among the measurement data of the distance sensor 140. Subsequently, the controller 180 acquires data indicating the distance between the projection device 10 and the screen 30 in the direction in which the angle formed with the optical axis of the projection lens of the projection device 10 is the angle β set in advance among the measurement data of the distance sensor 140. Subsequently, the controller 180 detects, from the setting data, the first data corresponding to the measurement data in the optical axis direction of the projection lens of the projection device 10. Subsequently, the controller 180 acquires the second data registered in association with the first data. Subsequently, the controller 180 calculates the angle α formed by the screen 30 and the projection device 10 based on a ratio of the second data acquired from the setting data and the measurement data in the direction in which the angle formed with the optical axis of the projection lens of the projection device 10 is the angle β set in advance and the conversion table. When an angle associated with the calculated ratio is absent in the conversion table, the controller 180 sets, as the angle α, an angle associated with a ratio in the conversion table closest to the calculated ratio.

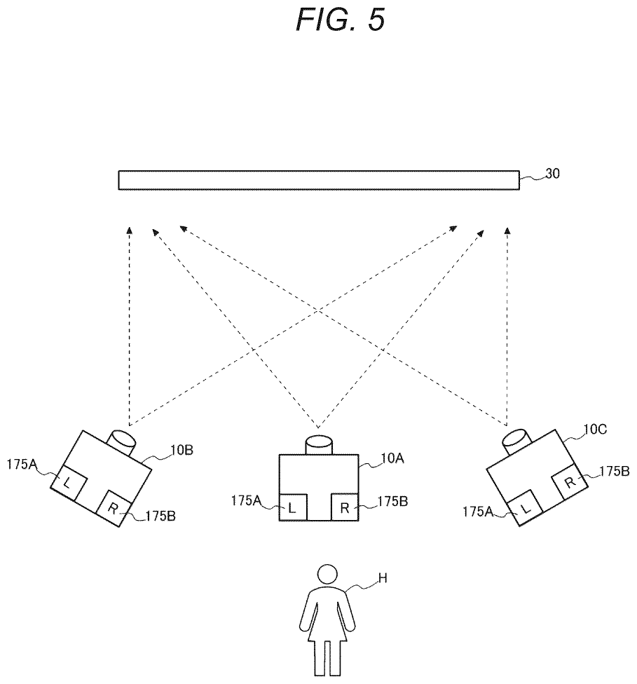

FIG. 5 is a diagram illustrating a disposition example of the projection device 10 with respect to the screen 30.

The projection device 10 installed in parallel to the screen 30 is written as a projection device 10A. The projection device 10 installed on the left side of the screen 30 in a drawing view is written as a projection device 10B. The projection device 10B illustrated in FIG. 5 is installed to tilt with respect to the screen 30 such that the right end of the projection device 10B is farther away from the screen 30 than the left end of the projection device 10B in the drawing view.

The projection device 10 installed on the right side of the screen 30 in the drawing view is written as a projection device 10C. The projection device 10C illustrated in FIG. 5 is installed to tilt with respect to the screen 30 such that the left end of the projection device 10C is farther away from the screen 30 than the right end of the projection device 10C in the drawing view.

After calculating the angle α formed by the screen 30 and the projection device 10, the controller 180 controls outputs of the left speaker 175A and the right speaker 175B based on the calculated angle α.

A user H is located behind the projection device 10 and substantially at the center in the width direction of the screen 30 and views an image projected onto the screen 30 by the projection device 10.

When an installation state of the projection device 10 is a state of the projection device 10B illustrated in FIG. 5, the controller 180 sets the output of the right speaker 175B smaller than the output of the left speaker 175A. That is, the left speaker 175A is further separated from the user H than the right speaker 175B. For this reason, the controller 180 sets the output of the right speaker 175B smaller than the output of the left speaker 175A.

As an example of a method of determining the magnitudes of the outputs of the left speaker 175A and the right speaker 175B, there is a method of determining the magnitudes of the outputs based on the calculated angles α (α1 and α2) and a trigonometric ratio. As an example of a specific calculation method, there is a method of, when the output of the right speaker 175B is set to 1, setting the output of the left speaker 175A to 1+sinα.

When the installation state of the projection device 10 is a state of the projection device 10C illustrated in FIG. 5, the controller 180 sets the output of the left speaker 175A smaller than the output of the right speaker 175B. That is, the right speaker 175B is farther away from the user H than the left speaker 175A. For this reason, the output of the left speaker 175A is set smaller than the output of the right speaker 175B.

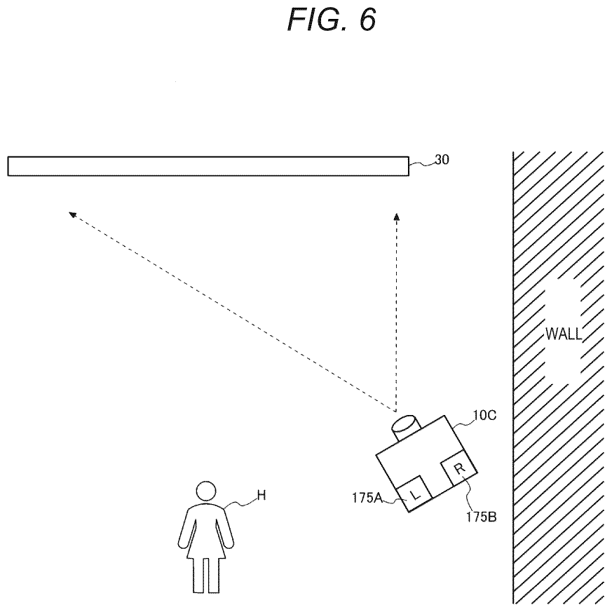

FIG. 6 is a diagram illustrating an example in which the projection device 10 is disposed near the wall in the room.

The controller 180 detects, based on the measurement data of the distance sensor 140, an object, the distance of which from the projection device 10 is within a distance set in advance. In FIG. 6, an example in which the projection device 10 is disposed near the wall in the room is illustrated.

When detecting an object, the distance of which from the projection device 10 is within the distance set in advance, the controller 180 controls the outputs of the speakers 175 based on the distance between the detected object and the projection device 10.

For example, as illustrated in FIG. 6, when there is a wall on the right side of the projection device 10 in the drawing view, the controller 180 controls the outputs of the speakers 175 such that the output of the right speaker 175B is smaller than the output of the left speaker 175A. Since the output of the right speaker 175B at the short distance from the wall is reflected on the wall and heard by the user H as larger sound, in this case, the controller 180 sets the output of the right speaker 175B smaller than the output of the left speaker 175A.

When causing the distance sensor 140 to measure the distance, the controller 180 drives the driver 150 to rotate the main body 100. By causing the distance sensor 140 to measure the distance while rotating the main body 100, it is possible to measure, over the entire periphery of the projection device 10, the distance to an object present around the projection device 10.

Further, the controller 180 causes, at every fixed time, the projector 300 to stop the projection of the image onto the screen 30. Thereafter, the controller 180 drives the driver 150 to rotate the main body 100 and causes the imager 160 to execute imaging. The imager 160 executes the imaging to generate a captured image and outputs the generated captured image to the controller 180. The controller 180 analyzes the captured image input from the imager 160 and determines whether a person is present around the projection device 10. When determining that a person is absent around the projection device 10 as a result of the image analysis, the controller 180 mutes the outputs of the speakers 175.

### 2. Operation of the Projection Device

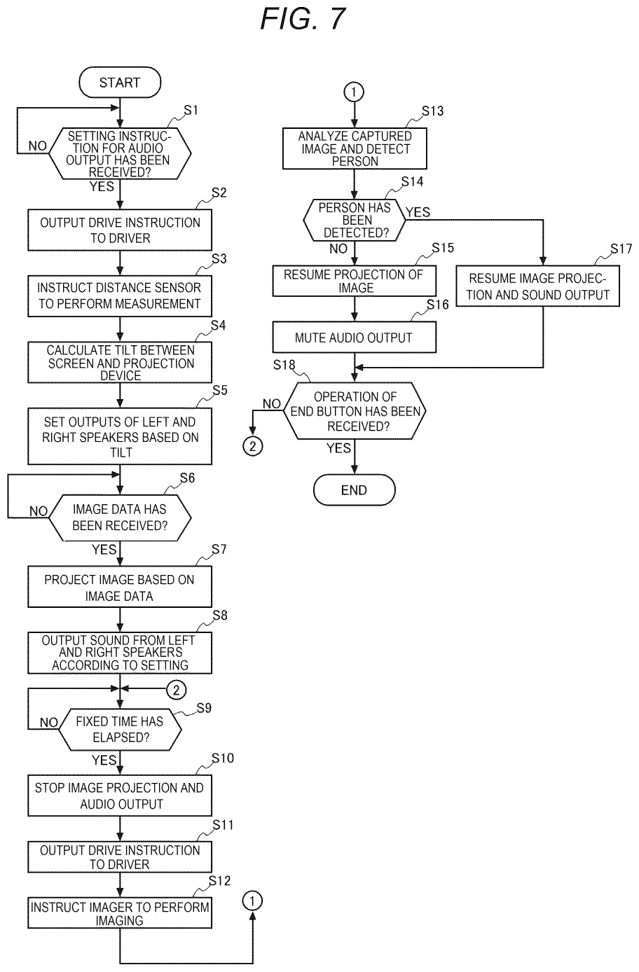

FIG. 7 is a flowchart illustrating an operation of the projection device 10. The operation of the projection device 10 is explained with reference to the flowchart of FIG. 7.

First, the controller 180 determines whether operation of instructing setting of an audio output has been received by the remote controller 135 (step S1). When the operation of instructing setting of an audio output has not been received by the remote controller 135 (step S1/NO), the controller 180 stays on standby until the operation is received.

When the operation of instructing setting of an audio output is received by the remote controller 135 (step S1/YES), the controller 180 outputs a drive instruction to the driver 150 (step S2) and rotates the main body 100 in the horizontal direction. The controller 180 causes the distance sensor 140 to execute distance measurement (step S3).

Subsequently, the controller 180 acquires measurement data of the distance sensor 140 and calculates a tilt of the projection device 10 with respect to the screen 30 based on the acquired measurement data (step S4).

Subsequently, the controller 180 sets the outputs of the left and right speakers 175 based on the calculated tilt (step S5).

Subsequently, the controller 180 determines whether image data has been received from the information processing device via the communication I/F 110 (step S6).

When image data has not been received (step S6/NO), the controller 180 waits until image data is received.

When receiving image data from the information processing device (step S6/YES), the controller 180 generates image light based on the received image data and projects the generated image light onto the screen 30 (step S7).

The controller 180 outputs sound from the left speaker 175A and the right speaker 175B according to the setting in step S5 (step S8). At this time, the controller 180 controls the volume of the sound output from the left speaker 175A and the right speaker 175B.

Subsequently, the controller 180 determines whether a fixed time has elapsed after causing the projector 300 to project the image light (step S9). When the fixed time has not elapsed (step S9/NO), the controller 180 stays on standby until the fixed time elapses.

When the fixed time has elapsed (step S9/YES), the controller 180 causes the projector 300 to stop the projection of the image light, causes the speakers 175 to stop the audio output (step S10), and outputs a drive instruction to the driver 150 (step S11) to rotate the main body 100.

Subsequently, the controller 180 instructs the imager 160 to perform imaging (step S12). The imager 160 starts capturing an image according to the instruction of the controller 180. The imager 160 generates a captured image and outputs the generated captured image to the controller 180.

The controller 180 acquires the captured image input from the imager 160. The controller 180 analyzes the acquired captured image and detects a person imaged in the captured image (step S13). When a person has been detected from the captured image (step S14/YES), the controller 180 resumes the image projection and the audio output (step S17).

When a person has not been successfully detected from the captured image (step S14/NO), the controller 180 resumes the image projection (step S15) and mutes the audio output from the speakers 175 (step S16).

Subsequently, the controller 180 determines whether operation of an end button provided on the remote controller 135 has been received (step S18). When the operation of the end button has not been received (step S18/NO), the controller 180 returns to the determination in step S9. When the operation of the end button is received (step S18/YES), the controller 180 causes the projector 300 to end the image projection, causes the speakers 175 to stop the audio output, and ends the processing flow.

### 3. Other Embodiments

In the embodiment explained above, the configuration in which the projection device 10 includes the speakers 175 is explained. However, the speakers 175 may be provided separately from the projection device 10. In this case, for example, the controller 180 causes the projection device 10 to project, onto the screen 30, a user interface image including a figure corresponding to the projection device 10 and for receiving operation of designating the positions of the speakers 175. The user operates the remote controller 135 or a not-illustrated operation unit provided in the projection device 10 to designate the positions of the speakers 175 with respect to the projection device 10.

The embodiment explained above is a preferred embodiment of the present disclosure. However, the present disclosure is not limited to the embodiment explained above and various modifications can be made without departing from the gist of the present disclosure.

For example, in the example explained in the embodiment, the processor 195 of the projection device 10 calculates a tilt of the projector 300 with respect to the screen 30 and controls outputs of the speakers 175 based on the calculated tilt. Besides this configuration, an information processing device such as a personal computer may be connected to the projection device 10 by wire or radio and the information processing device may execute the processing executed by the processor 195 of the projection device 10. In this case, the information processing device acquires the measurement data of the distance sensor 140 from the projection device 10, calculates a tilt of the projector 300 with respect to the screen 30, and transmits data for instructing setting of outputs of the speakers 175 based on the calculated tilt to the projection device 10.

The functional units of the projection device 10 illustrated in FIG. 1 indicate functional components and specific implementation forms of the functional units are not particularly limited. That is, pieces of hardware individually corresponding to the functional units do not always need to be installed and it is also naturally possible to adopt a configuration in which one processor executes a program to thereby implement functions of a plurality of functional elements. Some of functions implemented by software in the embodiment explained above may be implemented by hardware and some of functions implemented by hardware may be implemented by software.

The processing units of the flowchart of FIG. 7 are divided according to the main processing contents in order to facilitate understanding of the operation of the projection device 10. The present disclosure is not limited by the way of division and the names of the processing units illustrated in the flowchart of FIG. 7. The processing of the projection device 10 can also be divided into a larger number of processing units according to the processing contents and one processing unit can also be divided to include a larger number of kinds of processing. The processing order of the flowchart explained above is not limited to the illustrated example.

The projection device 10 illustrated in FIG. 4 has the configuration in which the distance sensor 140 is disposed on the optical axis. However, the distance sensor 140 may be disposed in a place other than on the optical axis of the projection device 10. For example, the distance sensor 140 may be disposed at an end of the projection device 10. However, when the distance sensor 140 is disposed in the place other than on the optical axis of the projection device 10, correction for converting the measurement data of the distance sensor 140 into a distance in the optical axis direction is necessary.

It is explained above that, when the installation state of the projection device 10 is the state of the projection device 10B illustrated in FIG. 5, the controller 180 sets the output of the right speaker 175B smaller than the output of the left speaker 175A. However, the controller 180 may set the output of the right speaker 175B larger than the output of the left speaker 175A. That is, the controller 180 sets an output of a speaker on a near side to the screen 30 smaller than an output of a speaker on a far side from the screen 30. Accordingly, echo sound from the screen 30 can be reduced. As an example of a method of determining the magnitudes of the outputs of the left speaker 175A and the right speaker 175B at this time, there is a method of determining the magnitudes of the outputs based on the calculated angles α (α1 and α2) and a trigonometric ratio. As an example of a specific calculation method, there is a method of, when the output of the right speaker 175B is set to 1+sinα, setting the output of the left speaker 175A to 1.

The same control as the control explained above is possible for the projection device 10C as well.

In FIG. 3, the configuration in which the projector 300 includes the transmissive liquid crystal panels 330R, 330G, and 330B is illustrated. However, the light modulation device may have a configuration including three reflective liquid crystal panels 330 or may adopt a system in which one liquid crystal panel and a color wheel are combined. Alternatively, the projector 300 may be configured by a system in which three digital mirror devices are used, a DMD system in which one digital mirror device and a color wheel are combined, or the like. When only one liquid crystal panel 330 or DMD is used as the light modulation device, a member equivalent to a combination optical system such as a cross dichroic prism is unnecessary. Besides the liquid crystal panel 330 and the DMD, any light modulation device capable of modulating light emitted by a light source can be adopted without any problem.

When the program of the present disclosure is executed by the processor 195 provided in the projection device 10, the program to be executed by the processor 195 can be configured in a form of a recording medium. The program to be executed by the processor 195 can also be configured in a form of a transmission medium for transmitting the program. As the recording medium, a magnetic or optical recording medium or a semiconductor memory device can be used. Specifically, examples of the recording medium include a portable or stationary recording medium such as a flexible disc, an HDD, a compact disc read-only memory (CD-ROM), a digital versatile disk (DVD), a Blu-ray disc, a magneto-optical disc, a flash memory, or a card-type recording medium. The recording medium may be a nonvolatile storage device such as a RAM, a ROM, or an HDD, which is an internal storage device provided in a server apparatus. Blu-ray is a registered trademark.

### 4. Summary of the Present Disclosure

A summary of the present disclosure is appended below.

### Appendix 1

A projection device including: a distance sensor configured to measure distances to a plurality of positions on a projection surface and output measurement values indicating the measured distances to the plurality of positions; a plurality of speakers; one or a plurality of processors; and a projector configured to project an image onto the projection surface, wherein the one or the plurality of processors execute: calculating a tilt of the projector with respect to the projection surface based on the measurement values output by the distance sensor; and controlling outputs of the plurality of speakers based on the tilt.

With this configuration, the tilt of the projector with respect to the projection surface is calculated based on the measurement values output by the distance sensor and the outputs of the plurality of speakers are controlled based on the calculated tilt. For this reason, it is possible to adjust the volume of sound heard from the plurality of speakers and it is possible to provide a comfortable sound space to a user who views a video projected onto the projection surface.

### Appendix 2

The projection device described in Appendix 1, wherein the one or the plurality of processors detect, based on the measurement values output by the distance sensor, an object present around the projection device and control the outputs of the plurality of speakers based on a distance to the detected object.

With this configuration, when an object is present around the projection device, the outputs of the plurality of speakers are controlled based on the distance to the object. For this reason, it is possible to control the outputs of the plurality of speakers considering sound reflected on the object present around the projection device and it is possible to provide a comfortable sound space to the user who views a video projected onto the projection surface.

### Appendix 3

The projection device described in Appendix 1 or 2, further including: a main body configured to house at least a part of the projector; and a driver configured to rotate the main body in a predetermined direction, wherein the one or the plurality of processors cause the driver to rotate the main body in the predetermined direction and cause the distance sensor to execute measurement.

With this configuration, since the one or the plurality of processors cause the distance sensor to execute measurement while rotating the main body in the predetermined direction, it is possible to accurately detect objects present in a plurality of directions around the projection device and it is possible to provide a comfortable sound space to the user who views a video projected onto the projection surface.

### Appendix 4

The projection device described in Appendix 3, further including a detection sensor configured to detect presence or absence of a person around the projection device, wherein the one or the plurality of processors cause the driver to rotate the main body in the predetermined direction, determine, based on a detection result of the detection sensor, whether a person is present around the projection device, and, when determining that a person is absent around the projection device, mute the outputs of the plurality of speakers.

With this configuration, it is determined, based on the detection result of the detection sensor, whether a person is present around the projection device and, when it is determined that a person is absent around the projection device, the outputs of the plurality of speakers are muted. For this reason, when a user who views a video projected by the projection device is absent around the projection device, it is possible to mute sound.

### Appendix 5

A projection system including: a plurality of speakers; and a projection device, the projection device including: a distance sensor configured to measure distances to a plurality of positions on a projection surface and output measurement values indicating the measured distances to the plurality of positions; one or a plurality of processors; and a projector configured to project an image onto the projection surface, wherein the one or the plurality of processors execute: calculating a tilt of the projector with respect to the projection surface based on the measurement values output by the distance sensor; and controlling outputs of the plurality of speakers based on the tilt.

With this configuration, the tilt of the projector with respect to the projection surface is calculated based on the measurement values output by the distance sensor and the outputs of the plurality of speakers are controlled based on the calculated tilt. For this reason, it is possible to adjust the volume of sound heard from the plurality of speakers and it is possible to provide a comfortable sound space to a user who views a video projected onto the projection surface.

### Appendix 6

A non-transitory computer-readable storage medium storing a program to be executed by a processor mounted on an information processing device, the program causing the processor to execute: calculating a tilt of a projection device, which projects an image onto a projection surface, with respect to the projection surface based on distances to a plurality of positions on the projection surface measured by a distance sensor; and controlling outputs of a plurality of speakers based on the calculated tilt.

With this configuration, the tilt of the projection device, which projects an image onto the projection surface, with respect to the projection surface is calculated based on the measurement values output by the distance sensor and the outputs of the plurality of speakers are controlled based on the calculated tilt. For this reason, it is possible to adjust the volume of sound heard from the plurality of speakers and it is possible to provide a comfortable sound space to a user who views a video projected onto the projection surface.

What is claimed is:

1. A projection device comprising:
a distance sensor configured to measure distances to a plurality of positions on a projection surface and output measurement values indicating the measured distances to the plurality of positions;
a plurality of speakers;
one or a plurality of processors; and
a projector configured to project an image onto the projection surface, wherein the one or the plurality of processors execute:
calculating a tilt of the projector with respect to the projection surface based on the measurement values output by the distance sensor; and
controlling outputs of the plurality of speakers based on the tilt.

2. The projection device according to claim 1, wherein the one or the plurality of processors detect, based on the measurement values output by the distance sensor, an object present around the projection device and control the outputs of the plurality of speakers based on a distance to the detected object.

3. The projection device according to claim 1, further comprising:
a main body configured to house at least a part of the projector; and
a driver configured to rotate the main body in a predetermined direction, wherein
the one or the plurality of processors cause the driver to rotate the main body in the predetermined direction and cause the distance sensor to execute measurement.

4. The projection device according to claim 3, further comprising a detection sensor configured to detect presence or absence of a person around the projection device, wherein
the one or the plurality of processors cause the driver to rotate the main body in the predetermined direction, determine, based on a detection result of the detection sensor, whether a person is present around the projection device, and, when determining that a person is absent around the projection device, mute the outputs of the plurality of speakers.

5. A projection system comprising:
a plurality of speakers; and
a projection device,
the projection device including:
a distance sensor configured to measure distances to a plurality of positions on a projection surface and output measurement values indicating the measured distances to the plurality of positions;
one or a plurality of processors; and
a projector configured to project an image onto the projection surface, wherein
the one or the plurality of processors execute:
calculating a tilt of the projector with respect to the projection surface based on the measurement values output by the distance sensor; and
controlling outputs of the plurality of speakers based on the tilt.

6. A non-transitory computer-readable storage medium storing a program to be executed by a processor mounted on an information processing device, the program causing the processor to execute:
calculating a tilt of a projection device, which projects an image onto a projection surface, with respect to the projection surface based on distances to a plurality of positions on the projection surface measured by a distance sensor; and
controlling outputs of a plurality of speakers based on the calculated tilt.
